(19) United States
(12) Patent Application Publication
(10) Pub. No.: US 2015/0252913 A1
(43) Pub. Date: Sep. 10, 2015

(54) CAGE-TYPE OF PRESSURE REDUCING DEVICE

(71) Applicant: Azbil Kimmon Co., Ltd., Tokyo (JP)

(72) Inventor: Kenichiro YAMAMOTO, Tokyo (JP)

(73) Assignee: AZBIL KIMMON CO., LTD., Tokyo (JP)

(21) Appl. No.: 14/640,071

(22) Filed: Mar. 6, 2015

(30) Foreign Application Priority Data
Mar. 10, 2014 (JP) 2014-046463

(51) Int. Cl. F16K 47/08

(52) U.S. Cl. CPC F16K 47/08

(57) ABSTRACT

In a cage-type of pressure reducing device, fewer small holes are formed in a bottommost rank of an outer peripheral variable cage portion than a per-rank number of small holes of other ranks. Moreover, a bottom end portion of a blocking wall surface of a plug is formed slanted so that an inner peripheral variable cage portion side is positioned higher than an outer peripheral variable cage portion side.

### CROSS REFERENCE TO RELATED APPLICATION

This application claims priority under 35 U.S.C. §119 to Japanese Patent Application No. 2014-046463, filed on Mar. 10, 2014, the entire content of which being hereby incorporated herein by reference.

### FIELD OF TECHNOLOGY

The present invention relates to a cage-type of pressure reducing device that is provided with a regulator or a regulator valve.

### BACKGROUND

Japanese Unexamined Patent Application Publication No. 2011-236962, for example, describes a cage-type pressure reducing device wherein an inner peripheral variable cage portion is provided along an inner peripheral surface of a blocking wall surface that has many holes and a plug, in addition to an outer peripheral variable cage portion that is provided along an outer peripheral surface of a blocking wall surface that has many holes and a plug, wherein the area of opening of the walls of the outer peripheral variable cage portion and the inner peripheral variable cage portion changes continuously concomitant with sliding of the blocking wall surface between the outer peripheral variable cage portion and the inner peripheral variable cage portion.

In the cage-type of pressure reducing device set forth above, when the blocking wall surface is slid upward from a state wherein the movement of the fluid into the holes on the inner peripheral variable cage portion from the holes in the outer peripheral variable cage portion is completely blocked, with the blocking wall surface positioned at the bottommost end of the slidable range thereof, a gap flow is produced first.

This gap flow is the clearance between the bottom end surface of the blocking wall surface that is formed through sliding the blocking wall surface upward, where the fluid escapes from the holes in the outer peripheral variable cage portion to the holes in the inner peripheral variable cage portion through the small clearance between the inner peripheral surface of the outer peripheral variable cage portion and the outer peripheral surface of the blocking wall surface, and the small clearance between the outer peripheral surface of the inner peripheral variable cage portion and the inner peripheral surface of the blocking wall surface, due to the ability to slide the blocking wall surface in the space between the outer peripheral variable cage portion and the inner peripheral variable cage portion.

When the blocking wall surface is slid further upward from the state wherein the gap flow is produced, the bottom end of the blocking wall surface arrives at the bottommost rank of the outer peripheral variable cage portion, the holes in the bottommost rank begin to open, producing a state wherein the valve opening (that is, the proportion of the total area of holes through which the fluid can pass, from among the holes in the variable cage portion) is extremely small. Given this, the flow of the fluid transitions from a gap flow to a normal flow.

The normal flow is a flow where in the fluid escapes from the holes of the outer peripheral variable cage portion directly through the clearance at the bottom end face of the blocking wall surface into the holes of the inner peripheral variable cage portion.

At the time of this transition from the gap flow to the normal flow, the flow rate of the fluid that escapes from the holes in the outer peripheral variable cage portion through the clearance at the bottom end face of the blocking wall surface into the holes of the inner peripheral variable cage portion increases abruptly, so control is difficult, and the fluid with the abrupt increase in the flow causes the plug to flutter. This produces vibrations, cavitation, and the like.

When a particularly high pressure fluid flows into the cage-type pressure reducing device, the state of fluttering will be different from a case wherein a normal medium-pressure fluid flows in, so that the noise and vibration produced by this fluttering will be substantial.

The present invention is to solve issues such as set forth above, and an aspect thereof is to provide a cage-type pressure reducing device able to suppress the occurrence of noise, vibration, cavitation, and the like when reducing the pressure of a fluid, and to achieve stable control, through transitioning smoothly from gap flow to normal flow.

### SUMMARY

Given this, the cage-type of pressure reducing device according to the present invention is a cage-type of pressure reducing device wherein a fluid from an upstream side undergoes a pressure reduction and flows to a downstream side. The cage-type of pressure reducing device includes: an outer peripheral variable cage portion of having many holes into which fluid from the upstream side flows; an inner peripheral variable cage portion, disposed on the inner peripheral side of the outer peripheral variable cage portion, having many holes into which fluid from the outer peripheral variable cage portion flows; a plug having a blocking wall surface, disposed between the outer peripheral variable cage portion and the inner peripheral variable cage portion, for changing continuously, through sliding, holes of the outer peripheral variable cage portion and of the inner peripheral variable cage portion through which fluid can pass; and a stationary cage, having many holes through which fluid from the inner peripheral variable cage portion flows to the downstream side. Fewer holes are formed in the bottommost rank of the outer peripheral variable cage portion than the per-rank number of holes of another rank. A bottom end portion of the blocking wall surface is slanted so that the inner peripheral variable cage portion side is positioned higher than the outer peripheral variable cage portion side.

The present invention is able to suppress a sudden increase in the flow rate of the fluid through the holes in the outer peripheral variable cage portion, and thus to suppress fluttering of plugs caused by the abrupt increase in the fluid, when transitioning from gap flow to normal flow, through having the holes of the bottommost rank in the outer peripheral variable cage portion be smaller, on a per-rank basis, then the holes in the other ranks. Moreover, the bottom end portion of the blocking wall surface that has the plugs is slanted so that the inner peripheral variable cage portion side will be positioned higher than the outer peripheral variable cage portion side, to thereby suppress the production of fluttering at the plugs caused by the pressure of the fluid being retained in the clearance at the bottom end face of the blocking wall surface. Consequently, this is able to achieve prevention of noise, vibration, cavitation, and the like, and to achieve stable control, when reducing the pressure of the fluid.

### BRIEF DESCRIPTIONS OF THE DRAWINGS

FIG. 1 is a cross-sectional diagram illustrating a structure of a cage-type pressure reducing device according to an example according to the present invention.

FIG. 2 is a side view of an outer peripheral variable cage portion and the example according to the present invention.

FIG. 3 is a cross-sectional diagram enlarging critical portions of the cage-type pressure-reducing device according to the example according to the present invention.

FIG. 4 is a side view illustrating another example of an arrangement of small holes in the variable cage portion in the example according to the present invention, and a cross-sectional diagram enlarging critical portions thereof.

FIG. 5 is a side view illustrating another example of an arrangement of small holes in the variable cage portion in the example according to the present invention, and a cross-sectional diagram enlarging critical portions thereof.

FIG. 6 is a side view illustrating the outer peripheral variable cage portion of a reference example for facilitating understanding of the outer peripheral variable cage portion in the example according to the present invention.

### DETAILED DESCRIPTION

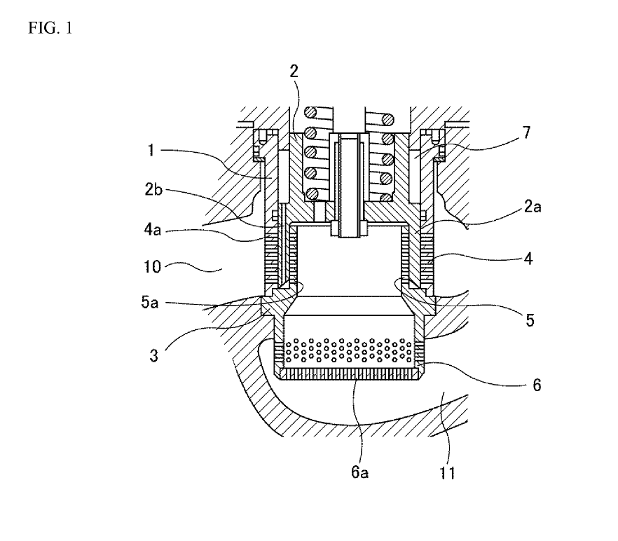

FIG. 1 is a cross-sectional diagram illustrating a structure of a cage-type pressure reducing device according to an example according to the present invention.

A cage-type pressure reducing device that is provided in a regulator or a regulator valve, as illustrated in FIG. 1, is structured with a first cage 1, a plug 2, and a second cage 3 disposed between a primary-side flow path 10, on an upstream side, wherein a high-pressure fluid flows, and a secondary side flow path 11, on a downstream side. This first cage 1 has an outer peripheral variable cage portion 4. The second cage 3 has an inner peripheral variable cage portion 5 and a stationary cage portion 6.

The outer peripheral variable cage portion 4 reduces the pressure of the fluid from the primary-side flow path 10, and is disposed on the outer peripheral side of the plug 2, and has a large number of small holes 4a formed in a lower portion of the side face. In this outer peripheral variable cage portion 4, the total area of the small holes 4a through which a fluid can pass from the primary-side flow path 10 (the opening area) is changed continuously through the blocking wall surface 2a, described below, of the plug 2 sliding upward or downward. The fluid for which the pressure has been reduced by the outer peripheral variable cage portion 4 flows to the inner peripheral variable cage portion 5 side.

The inner peripheral variable cage portion 5 is to reduce the pressure of the fluid from the outer peripheral variable cage portion 4, and is disposed on the inner peripheral side of the plug 2, and has a large number of small holes 5a formed in the lower portion of the side face thereof. In this inner peripheral variable cage portion 5, the total area of the small holes 5a through which a fluid can pass from the outer peripheral variable cage portion 4 is changed continuously through the blocking wall surface 2a of the plug 2 sliding upward or downward. The fluid for which the pressure has been reduced by the inner peripheral variable cage portion 5 flows to the stationary cage portion 6 side.

The plug 2 is disposed between the outer peripheral variable cage portion 4 and the inner peripheral variable cage portion 5, and has a blocking wall surface 2a for limiting the amount of fluid that passes through the small hole 4a and 5a parts. This plug 2 is moved upward or downward by an operating device, not shown, so that the blocking wall surface 2a is slid in the space between the outer peripheral variable cage portion 4 and the inner peripheral variable cage portion 5, to change continuously the opening areas of the outer peripheral variable cage portion 4 and the inner peripheral variable cage portion 5.

Moreover, a pressure equalizing space 7 is formed at the top end portion side of the blocking wall surface 2a, and a pressure equalizing hole 2b that passes through from the bottom end portion toward the pressure equalizing space 7 is formed in the blocking wall surface 2a. This equalizing hole 2b is able to prevent the application of an excessive load on the operating device that operates the plug 2, through suppressing imbalanced forces on the blocking wall surface 2a (forces that would press the blocking wall surface 2a upward) that would be produced on the bottom end portion side of the blocking wall surface 2a when the blocking wall surface 2a is slid upward and fluid flows into the inner peripheral variable cage portion 5. This is because imbalanced forces on the blocking wall surface 2a are canceled out through causing, through the pressure equalizing hole 2b, the bottom end portion side of the blocking wall surface 2a to be at the same pressure as the pressure equalizing space 7.

The stationary cage portion 6 is for reducing the pressure of the fluid from the inner peripheral variable cage portion 5, and is disposed lower than the inner peripheral variable cage portion 5, with a large number of small holes 6a formed in the lower portion of the side face and in the bottom face thereof. The fluid for which the pressure has been reduced by the stationary cage portion 6 flows into a flow path 11 on the secondary side.

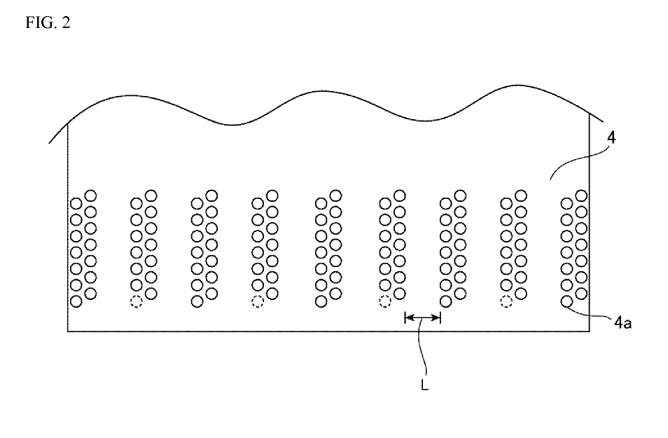

Here a side view of the outer peripheral variable cage portion 4 is given in FIG. 2.

For the small holes 4a of the outer peripheral variable cage portion 4, the small holes 4a, which are lined up in multiple ranks, are lined up regularly, with a gap L left between every second column. Moreover, for the small holes 4a that are positioned nearest to the bottom end of the outer peripheral variable cage portion 4, these holes are lined up alternating between the holes being omitted (indicated by the dotted lines in FIG. 2) and not being omitted, alternating with every second column, so that the number of small holes 4a in the lowest rank (of which 5 can be seen in FIG. 2) will be less than the per-rank number of small holes 4a in other ranks (of which 9 can be seen in FIG. 2).

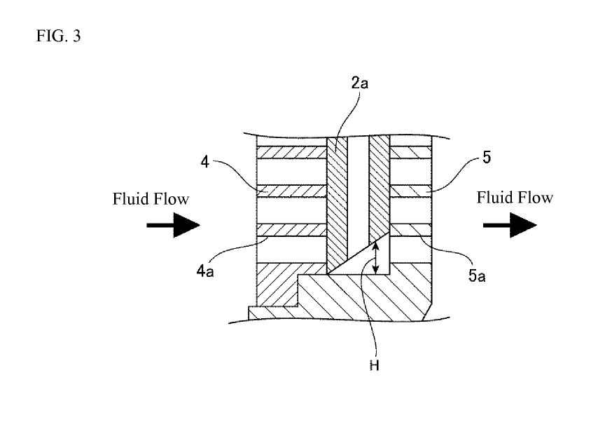

Moreover, small holes 5a of the inner peripheral variable cage portion 5 are formed in the same positions corresponding to the small holes 4a of the outer peripheral variable cage portion 4 that is illustrated in FIG. 1, where a cross-sectional diagram in the vicinity of the small holes 4a and 5a of the bottommost rank is shown together with the bottom end portion of the blocking wall surface 2a of the plug 2 in FIG. 3.

The bottom end portion of the blocking wall surface 2a is formed with a slant so that the inner peripheral variable cage portion 5 side will be positioned higher than the outer peripheral variable cage portion 4 side, so that the clearance H at the bottom end face of the blocking wall surface 2a will be formed so as to be larger on the inner peripheral variable cage portion 5 side than on the outer peripheral variable cage portion 4 side.

As illustrated in FIG. 2, having the number of small holes 4a in the bottommost rank (wherein 5 can be seen in FIG. 2) be less than the per-rank number of small holes 4a in the other ranks of (wherein 9 can be seen in FIG. 2) makes it possible to keep the total area of the small holes 4a through which fluid can flow small at the time that the blocking wall surface 2a is slid upward and the bottom end thereof arrives at the bottommost rank of small holes 4a of the outer peripheral variable cage portion 4, to produce a state wherein the valve opening has moved from zero to being very small, that is, at the time of the transition from the gap flow to the normal flow. Consequently, this makes it possible to suppress the occurrence of the abrupt flow and the fluttering of the plug 2 due to this flow, caused by the abrupt increase, at the time of this transition from the gap flow to the normal flow, of the flow rate of the fluid that escapes through the clearance H at the bottom end face of the blocking wall surface 2a from the small holes 4a in the bottommost rank of the outer peripheral variable cage portion 4 to the small holes 5a of the inner peripheral variable cage portion 5.

This makes it possible to suppress the production of noise, vibration, cavitation, and the like through producing stable control even when the valve opening is extremely small, through a smooth transition from gap flow to normal flow.

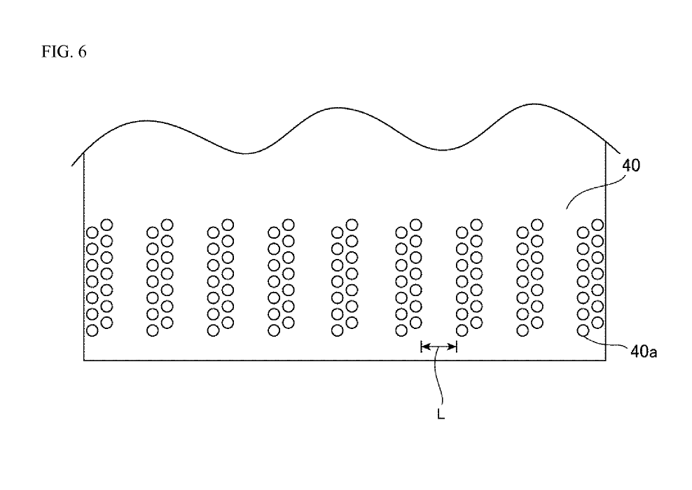

On the other hand, a side view of the outer peripheral variable cage portion 40 is given in FIG. 6 as a reference example for facilitating an understanding of the present invention. For the small holes 40a of the outer peripheral variable cage portion 40, the small holes 40a, which are lined up in multiple ranks, are lined up regularly, with a gap L left between every second column. Moreover, while in FIG. 2 some small holes, indicated by the dotted lines, are omitted, in the reference example illustrated in FIG. 6 the small holes 40a are formed without these omissions. That is, the number of small holes 40a in the bottommost rank (of which 9 can be seen in FIG. 6) is the same as the per-rank number of small holes 40a in the other ranks (of which 9 can be seen in FIG. 6).

When compared to the case of the outer peripheral variable cage portion 4 illustrated in FIG. 2, when the small holes 40a are formed as illustrated in FIG. 6 the total area of the small holes in the bottommost rank through which the fluid is able to pass at the time of the transition from gap flow to normal flow is larger. As a result, the increase in the flow rate of the fluid that flows into the small holes 40a at the bottommost rank of the outer peripheral variable cage portion 40 at the time of the transition from gap flow to normal flow increases abruptly, producing the abrupt flow, where this flow causes the plug to flutter.

Moreover, returning to FIG. 3 for the explanation, the fluid that passes through the small holes 4a of the bottommost rank of the outer peripheral variable cage portion 4 at the time of the transition from gap flow to normal flow continues on to pass through the clearance H at the bottom end face of the blocking wall surface 2a, but, at this time, if an adequate flow path cannot be secured for escaping to the small holes 5a of the inner peripheral variable cage portion 5 through the clearance H at the bottom end face of the blocking wall surface 2a, then the fluid that flows through the small holes 4a of the bottommost rank will not be able to flow smoothly through the flow path, causing the plug 2 to be pushed upward by the fluid, that is, causing a fluttering state. Given this, slanting the bottom end portion of the blocking wall surface 2a so that the inner peripheral variable cage portion 5 side will be higher than the outer peripheral variable cage portion 4 side ensures an adequate flow path to escape to the small holes 5a of the inner peripheral variable cage portion 5 through the clearance H at the bottom end face of the blocking wall surface 2a, thereby making it possible to prevent the retention of fluid pressure in the clearance H at the bottom end face of the blocking wall surface 2a. This makes it possible to suppress even further the fluttering of the plug 2 by the fluid.

Note that the small holes 5a of the inner peripheral variable cage portion 5 need not necessarily be formed in exactly the same positions as the small holes 4a of the outer peripheral variable cage portion 4, but rather small holes 5a may also be formed in positions that are the same as those corresponding to the holes 4a that have been omitted, indicated by the dotted lines in FIG. 2. Furthermore, additional small holes 5a may be formed in the bottommost rank at positions wherein it is possible to form additional small holes 5a at the same horizontal height positions as the small holes 5a of the bottom rank (such as positions within the gap L that is provided regularly between every second column, shown in FIG. 2). Doing this makes it possible to further suppress the fluttering of the plug 2 that is caused through the retention of fluid pressure at the clearance H at the bottom end face of the blocking wall surface 2a, given that the number of small holes 5a, in the bottommost rank, through which the fluid that has passed through the small holes 4a of the bottommost rank can pass is greater than the number of holes 4a in the bottommost rank.

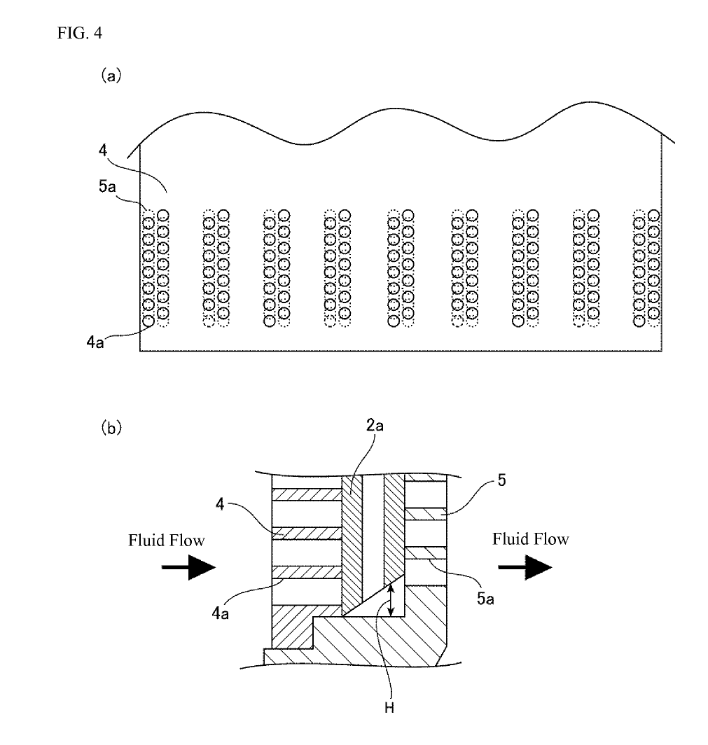

Moreover, FIG. 4 (a) shows a case wherein, in order to obtain pressure-reducing performance that is different from that which is illustrated in FIG. 2, the small holes 4a of the outer peripheral variable cage portion 4 and the small holes 5a of the inner peripheral variable cage portion 5 are not arranged coaxially, but rather are arranged with the positions of the centers shifted from each other. The solid lines show the small holes 4a that are formed in the outer peripheral variable cage portion 4, and the dotted lines show the small holes 5a that are formed in the inner peripheral variable cage portion 5.

Having the small holes 4a in the outer peripheral variable cage portion 4 be lined up in an orderly manner with multiple ranks, with spaces between every second column, and having omissions of the small holes 4a at the positions that are nearest to the bottom end of the outer peripheral variable cage portion 4 (indicated by the dotted lines in FIG. 4 (a)), and places where in the small holes 4a are not omitted be arranged alternatingly with every second column is the same as in FIG. 2 in the point that the number of small holes 4a in the bottommost rank (of which 5 can be seen in FIG. 4 (a)) is smaller than the per-rank number of small holes 4a in the other ranks (of which 9 can be seen in FIG. 4 (a)). Consequently, in the same manner as that which was explained using FIG. 2, this structure is able to prevent the abrupt flow, and the occurrence of fluttering of the plug 2 due to this flow, given the abrupt increase, at the time of the transition from gap flow to normal flow, of the flow rate of the fluid that escapes to the small holes 5a of the inner peripheral variable cage portion 5 through the clearance H at the bottom end face of the blocking wall surface 2a from the small holes 4a of the bottommost rank of the outer peripheral variable cage portion 4.

FIG. 4 (b) shows a cross-sectional diagram in the vicinity of the small holes 4a of the bottommost rank of the outer peripheral variable cage portion 4 and the small holes 5a of the bottommost rank of the inner peripheral variable cage portion 5, shown in FIG. 4 (a), together with the bottom end portion of the blocking wall surface 2a.

The slanting of the bottom end portion of the blocking wall surface 2a so that the inner peripheral variable cage portion 5 side will be higher than the outer peripheral variable cage portion 4 side not only is able to secure an adequate flow path for the escape, to the small holes 5a of the bottommost rank that are lined up horizontally at the same height position as the small holes 4a of the bottommost rank, as illustrated in FIG. 4 (a) through the clearance H at the bottom end face of the blocking wall surface 2a from the small holes 4a of the bottommost rank, but also makes it possible to secure adequately flow paths for escaping to small holes 5a that are positioned with offsetted centers, as illustrated in FIG. 4 (b) (the small holes 5a in the rank immediately above the bottommost rank), and so, when compared to the case wherein the bottom end portion of the blocking wall surface 2a is not slanted, this makes it possible to further reduce fluttering of the plug 2 caused by the retention of fluid pressure in the clearance H at the bottom end face of the blocking wall surface 2a.

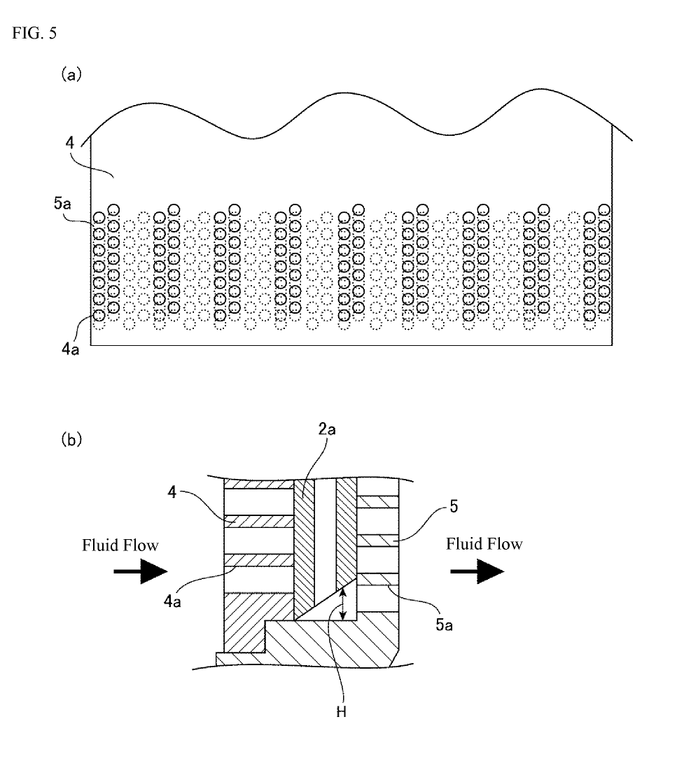

Moreover, as illustrated in FIGS. 5 (a) and (b), rather than the small holes 4a of the outer peripheral variable cage portion 4 and the small holes 5a of the inner peripheral variable cage portion 5 being arranged so as to be concentric, they may be arranged so that the positions of the centers are shifted relative to each other, and the number of small holes 4a in the bottommost rank (of which 5 can be seen in FIG. 5 (a)) may be less than the per-rank number of small holes 4a in other ranks (of which 9 can be seen in FIG. 5 (a)), where having the position of the small holes 5a in the bottommost rank of the inner peripheral variable cage portion 5 be lower than the position of the small holes 4a of the bottommost rank of the outer peripheral variable cage portion 4 can secure an adequate flow path for escaping from the small holes 4a of the bottommost rank through the clearance H at the bottom end face of the blocking wall surface 2a to the small holes 5a of the bottommost rank, even without providing a slant on the bottom end portion of the blocking wall surface 2a.

However, slanting the bottom end portion of the blocking wall surface 2a so that the position of the inner peripheral variable cage portion 5 side will be higher than that of the outer peripheral variable cage portion 4 side makes it possible to secure adequately a flow path for escaping to the small holes 5a (the small holes 5a of the rank that is one above the bottommost rank) that are lined up at the same horizontal height position as the small holes 4a of the bottommost rank, as illustrated in FIG. 5 (a), and also a flow path for escaping to the small holes 5a (the small holes 5a of the rank that is two above the bottommost rank) that are positioned with the centers shifted, as illustrated in FIG. 5 (b), so that, when compared to the case wherein the bottom end portion of the blocking wall surface 2a is not slanted, this can further reduce the fluttering of the plug 2 caused by retention of fluid pressure in the clearance H at the bottom end face of the blocking wall surface 2a.

Note that, as illustrated in FIG. 5 (a), having the number of small holes 4a be different from the number of small holes 5a can provide pressure reduction performance that is different from the case wherein the numbers of small holes are identical.

While FIG. 1 through FIG. 5 show examples wherein the relationships between the small holes 4a of the outer peripheral variable cage portion 4 and the small holes 5a of the inner peripheral variable cage portion 5, and the numbers of holes, are varied, the scope of application of the present invention is not limited to that which is illustrated. Note that arranging the small holes 4a of the outer peripheral variable cage portion 4 and the small holes 5a of the inner peripheral variable cage portion 5 so that the positions of the centers are mutually different can cause the fluid that is expelled from the small holes 4a to be dispersed to the surrounding small holes 5a after first striking the wall surface of the inner peripheral variable cage portion 5, to then flow to the stationary cage portion 6 side, which can improve the pressure-reducing performance when compared to the case wherein there is no offsetting of the center positions.

As described above, in the example, the number of small holes 4a in the bottommost rank of the outer peripheral variable cage portion 4 is less than the per-rank number of small holes 4a in other ranks in the outer peripheral variable cage portion 4, thus making it possible to prevent the occurrence of an abrupt flow, and of the fluttering of the plug 2 due to the flow, that escapes from the small holes 4a of the bottommost rank of the outer peripheral variable cage portion 4 through the clearance H at the bottom end face of the blocking wall surface 2a to the small holes 5a of the inner peripheral variable cage portion 5 at the time of the transition from the gap flow to the normal flow. Moreover, the bottom end portion of the blocking wall surface 2a is slanted so that the position of the inner peripheral variable cage portion 5 side will be higher than that of the outer peripheral variable cage portion 4 side, making it possible to prevent the occurrence of fluttering of the plug 2 that is caused by the retention of fluid pressure in the clearance H at the bottom end face of the blocking wall surface 2a. Consequently, this is able to achieve prevention of noise, vibration, cavitation, and the like, and to achieve stable control, when reducing the pressure of the fluid.

Moreover, the small holes 5a of the bottommost rank of the inner peripheral variable cage portion 5 are formed in a greater number than that of the small holes 4a of the bottommost rank of the outer peripheral variable cage portion 4, enabling a further reduction in the fluttering of the plug 2 caused by retention of the fluid pressure in the clearance H at the bottom end face of the blocking wall surface 2a.

Additionally, this example exhibits particularly superior effects in cases where particularly high-pressure fluids flow into the cage-type of pressure reducing device, which, conversely, has had a different mode of fluttering than the case wherein fluid of a normal pressure flows in, and which has had substantially more noise and vibration caused by this fluttering.

Note that in the invention in the present application, arbitrary structural elements in the example may be modified, or arbitrary structural elements in the example may be omitted, within the scope of the invention.

1. A cage-type of pressure reducing device wherein a fluid from an upstream side undergoes a pressure reduction and flows to a downstream side, the cage-type of pressure reducing device comprising:
an outer peripheral variable cage portion provided with holes into which fluid from the upstream side flows;
an inner peripheral variable cage portion, provided on the inner peripheral side of the outer peripheral variable cage portion and with holes into which fluid from the outer peripheral variable cage portion flows;
a plug having a blocking wall surface, provided between the outer peripheral variable cage portion and the inner peripheral variable cage portion, for changing continuously, through sliding, holes of the outer peripheral variable cage portion and of the inner peripheral variable cage portion through which fluid can pass; and
a stationary cage provided with holes through which fluid from the inner peripheral variable cage portion flows to the downstream side, wherein
fewer holes are formed in the bottommost rank of the outer peripheral variable cage portion than the per-rank number of holes of another rank, and
a bottom end portion of the blocking wall surface is slanted so that the inner peripheral variable cage portion side is positioned higher than the outer peripheral variable cage portion side.

2. A cage-type pressure reducing device as set forth in claim 1, wherein
more holes are formed in the bottommost rank of the inner peripheral variable cage portion than the number of holes in the bottommost rank of the outer peripheral variable cage portion.
